(19) United States
(12) Patent Application Publication
(10) Pub. No.: US 2006/0106855 A1
(43) Pub. Date: May 18, 2006

(54) Reusable row indices table

(75) Inventor: Steven R. Champagne, Waukesha, WI (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/979,293

(22) Filed: Nov. 2, 2004

(51) Int. Cl. G06F 17/00; G06F 7/00

(52) U.S. Cl. 707/102

(57) ABSTRACT

A method and article of manufacture for managing uniquely indexed segments (304) within a table (302) on a computer system. A segment incarnation number (308) indicates the current status of the segment and the number of times the segment (304) has been added to the table (302). A nextincarnation number (310) indicates the next value to be assigned to the incarnation number if the segment is again added to the table (302). The segments (304) can be accessed or deleted by the provision of a segment index (314) and an accurate incarnation value (308). Any segment with a zero-value incarnation number can be added to the table. The table (302) is stored on a data storage device connected to a computer.

### BACKGROUND OF THE INVENTION

1. Field of the Invention

The present invention relates generally to computer-implemented database management systems, and, in particular, to generating and utilizing table values to uniquely identify a row, its status, and history within a table.

2. Background of the Invention

A database is a collection of stored data that is organized in tabular form. A table consists of one or more rows and columns of data. A database management system (DBMS) includes database management software, processing means, and computer hardware, including direct access storage devices and media. A relational database management system is a DBMS that uses relational techniques for storing and retrieving information. The relational database management system (RDBMS) comprises computerized information storage and retrieval systems in which data is stored on disk drives or media for semi-permanent storage, as well as software using a Structured Query Language (SQL) interface.

A DBMS typically includes database files and index files. The database files contain the actual data stored within the rows and columns of the tables. In a table of this type, the rows may correspond to individual records while the columns of the table represent attributes of the records. For example, in a computer hardware information table of a database management system, each row might represent a different piece of hardware, while each column represents different attributes of the hardware, such as the ID number of the hardware, a specification of the hardware, the date the hardware was installed, the last function the hardware performed, and other such information.

The DBMS can search each individual record in the table and compare the information within the record to a predetermined search criteria. Individual record searches of this kind suffer from the disadvantage of being slow and costly in terms of system resources.

As an alternative to direct sorting and searching of records in a table, the DBMS utilizes index files, containing information or pointers regarding the locations of a record in the table. The index files are quicker and easier to search and sort than the database files. A search is performed by stipulating criteria for selecting one or more records within one or more tables. The criteria include keys, which are the attributes by which the system finds the desired record or records using the index.

Each record within a table can be read, altered, or deleted, depending on the need for the information within the record and the space within the table. Once in use, it is not unexpected that a table will be accessed and altered millions of times. As the table is used over and over, more and more previously populated records are deleted and emptied out. As a result, the table suffers from the disadvantage of having empty records that take up unnecessary space within the table. This is due to the fact that even after a record is deleted, index numbers continue to exist and consume space within the index files that point to records. The table also suffers from the disadvantage of the populated records becoming interspersed between the blank records.

The practice of constantly adding new rows to the end of the table when a new record is created suffers from the disadvantage of quickly consuming large amounts of memory. Furthermore, programming techniques often require that a table is initially specified as a given size. These programs will not facilitate a table that continuously grows.

Accordingly, a need exists for table whose row indices remain constant after rows are added and deleted and remains non-sparse because unused “hole” rows are reused. Additionally, a need exists for a table whose rows can be accessed and verified at nearly direct access speeds.

### SUMMARY OF THE INVENTION

The present invention provides a method for managing segments within a table. In one embodiment of the present invention, a method includes generating a table with one or more addressable segments, where each segment has a plurality of table entries including at least one table entry for storing an incarnation value representing either the number of times the segment has been added to the table or a zero value if the segment is currently deleted from the table. The method also includes setting a value of a pointer that points to an addressable segment of the table, reading the incarnation value in the table entry within the addressable segment pointed to by the pointer. If the incarnation value is zero, the first pointer value will be incrementing by a predetermined quantity and a new segment will be pointed to and an incarnation value of the new segment read and compared to zero. The method will continue until a non-zero value is located.

If a non-zero (a value other than zero) incarnation value in a segment is located, the present invention compares the non-zero incarnation value to a given incarnation value and, if the incarnation value in the segment exactly matches the given incarnation value, one or more table entries within the segment are then accessed.

In another embodiment of the present invention, if a non-zero (a value other than zero) incarnation value in a segment is located, the present invention compares the non-zero incarnation value to a given incarnation value and, if the incarnation value in the segment exactly matches the given incarnation value, the incarnation value in the segment is set to zero.

In yet another embodiment of the present invention, a method includes reading an incarnation value in a table entry within an addressable segment corresponding to a pointer value, and in response to the incarnation value being non-zero, comparing the incarnation value to a given incarnation value. If the incarnation value is less than the given incarnation value, the method returns a status indicating that the given incarnation value is stale, and if the incarnation value is greater than the given incarnation value, the method returns a status indicating that the given incarnation value is invalid.

In still another embodiment of the present invention, a method includes adding a segment to a table by generating a table with one or more addressable segments, where each segment has a plurality of table entries. At least one table entry stores an incarnation value that is either the number of times the segment has been added to the table or is a zero value indicating that the segment is currently deleted from the table. The table also includes at least one table entry that holds a nextincarnation value that is defined as a mathematical incremental offset added to a highest value of the incarnation value. The method sets a value of a pointer that points to an addressable segment of the table and reads the incarnation value in the table entry within the addressable segment corresponding to the pointer value. If the incarnation value is non-zero, the method increments the first pointer value by a predetermined mathematical increment and reads the incarnation value of a newly addressed segment. If the incarnation value is zero, the method sets the incarnation value to the value of the nextincarnation value and increments the nextincarnation value by the mathematical incremental offset and accesses the table entries within the segment.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a hardware block diagram illustrating one embodiment of a prior-art computer system.

FIG. 2 is a prior-art table.

FIG. 3 is a table in accordance with an embodiment of the present invention.

FIG. 4 is a flow diagram illustrating a method of accessing a segment within the table of FIG. 3, in accordance with an embodiment of the present invention.

FIG. 5 is a flow diagram illustrating a method of deleting a segment from the table of FIG. 3, in accordance with an embodiment of the present invention.

FIG. 6 is a flow diagram illustrating a method of adding a segment to the table of FIG. 3, in accordance with an embodiment of the present invention.

FIG. 7 is an exemplary table corresponding to FIG. 3, which has been populated with records for managing computer resources, in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

Described now is an exemplary method and hardware platform for performing the method according to an exemplary embodiment of the present invention. The hardware platform includes a computer system.

Generalized Architecture for a Computer System

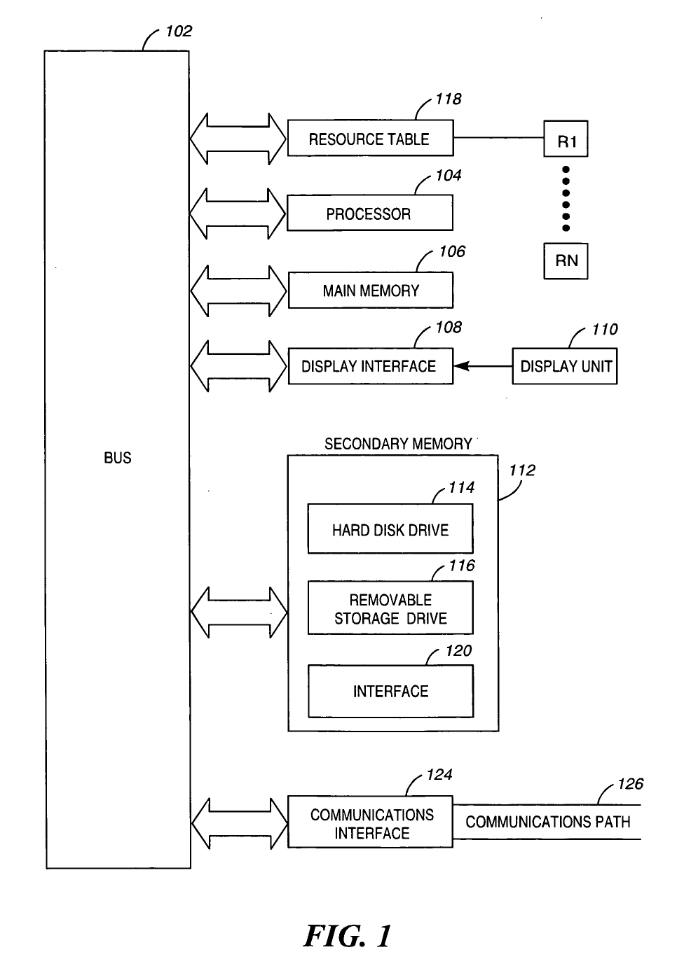

FIG. 1 is a block diagram of a computer system useful for implementing an embodiment of the present invention. The computer system includes one or more processors, such as processor 104. The processor 104 is connected to a communication infrastructure 102 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 108 that forwards graphics, text, and other data from the communication infrastructure 102 (or from a frame buffer not shown) for display on the display unit 110. The computer system also includes a main memory 106, preferably random access memory (RAM), and may also include a secondary memory 112. The secondary memory 112 may include, for example, a hard disk drive 114 and/or a removable storage drive 116, representing a floppy disk drive, a magnetic tape drive, an optical disk drive, etc. Removable storage drive 116, reads and writes to a floppy disk, magnetic tape, optical disk, etc., storing computer software and/or data. The system also includes a resource table 118, for managing resources R₁-Rₙ such as disk drives, disk arrays, tape drives, CPUs, memory, wired and wireless communication interfaces, displays and display interfaces, including all resources shown in FIG. 1, as well as others not shown.

In alternative embodiments, the secondary memory 112 may include other similar means for allowing computer programs or other instructions to be loaded into the computer system. Such means may include, for example, a removable storage unit 122 and an interface 120. Examples of such may include a program cartridge and cartridge interface (such as that found in video game devices), a removable memory chip (such as an EPROM, or PROM) and associated socket, and other removable storage units 122 and interfaces 120 which allow software and data to be transferred from the removable storage unit 122 to the computer system.

The computer system may also include a communications interface 124. Communications interface 124 allows software and data to be transferred between the computer system and external devices. Examples of communications interface 124 may include a modem, a network interface (such as an Ethernet card), a communications port, a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This channel 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 106 and secondary memory 112, removable storage drive 116, a hard disk installed in hard disk drive 114, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 106 and/or secondary memory 112. Computer programs may also be received via communications interface 124. Such computer programs, when executed, enable the computer system to perform the features of the present invention as discussed herein. In particular, the computer programs, when executed, enable the processor 104 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

Database

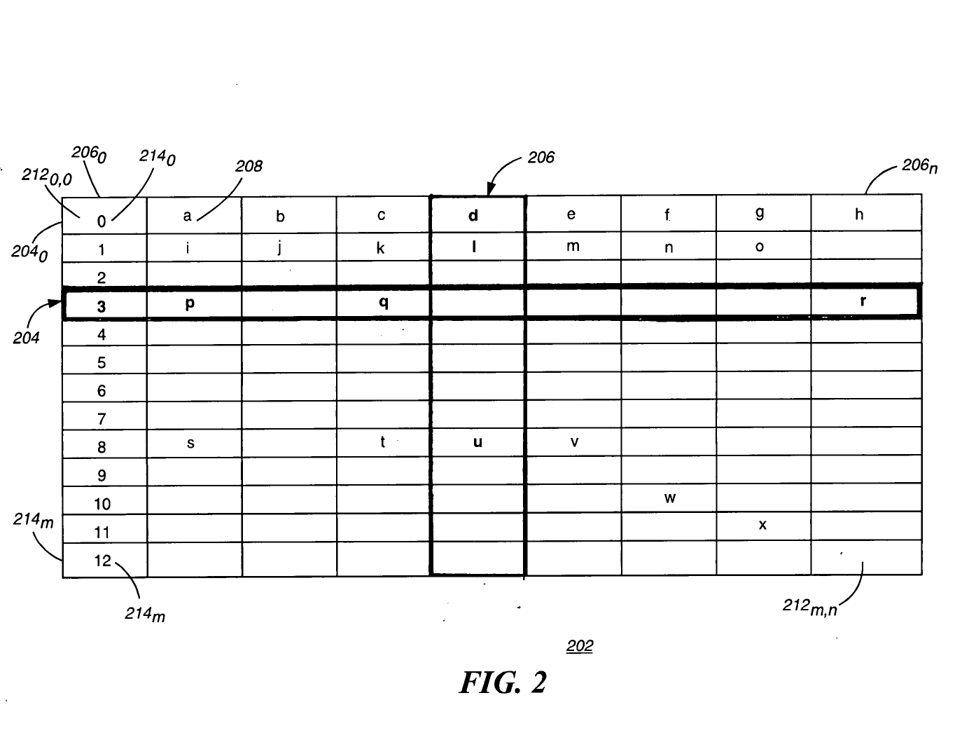

A database is a collection of stored data that is organized in tabular form. Referring now to FIG. 2, a table 202 according to an embodiment of the present invention, is shown, which includes one or more rows, or “segments” 204 and columns 206. For illustrative purposes, one of the segments 204 of table 202 is shown as a shaded set of horizontally adjacent boxes. Similarly, one of the columns 206 is shown as a shaded set of vertically adjacent boxes.

The table 202 is a zero-based table, meaning the first segment, or uppermost segment, is referred to as segment 0 and is identified as 204₀. There are “m” +1 segments in the table, so the last segment, or lowermost segment, of the table is identified as 204ₘ. Similarly, there are “n” +1 columns in the table, so the first column, or leftmost column, is referred to as column 0, identified as 206₀, and the rightmost column in the table, is labeled 206ₙ.

Each individual segment 204 intersects with a portion of every column 206₀₋ₙ in the table 202. A way to characterize the table is to consider each column 206₀₋ₙ dividing the segments 204₀₋ₘ into a plurality of table entries 212_{0,0-n,m}, so that each segment 204 will have (n+1) table entries 212, as there are (n+1) columns 206₀₋ₙ in the table. Data 208 can be stored within any of the table entries 212 of each segment 204 of the table 202.

A record that is stored within a segment 204 can contain a plurality of attributes of the subject of the record, with each attribute being stored within a table entry 212 in the single segment 204. In this organizational scheme, records having attributes belonging to common classes can be conveniently organized by lining up the common class attributes in the same column 206, which is known as a “field”.

In the table shown in FIG. 2, column 206₀ divides the segments 204₀₋ₘ so that each segment has a first table entry 212_{0,0-12,0} containing a unique index number 0-12, with 0 being in table entry 212_{0,0} and 12 being in table entry 212_{12,0}.

Each index number 214₀₋ₘ can be utilized to uniquely address a single segment 204. A pointer is given a pointer value that corresponds to the index number of the segment being addressed and will continue to point to that individual segment until a new value is stored in the pointer.

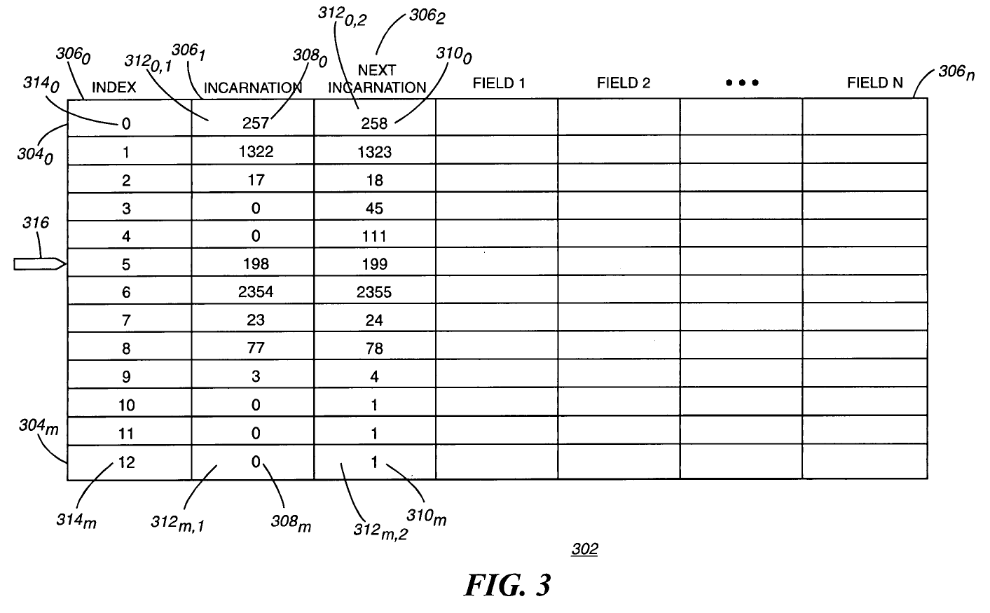

Referring now to FIG. 3, a table 302 is shown. Table 302 is organized exactly like table 202 in FIG. 2, with columns 306₀₋ₙ and segments 304₀₋ₘ. In one embodiment, table 302 is used to manage local or remote resources such as those described in the section entitled “Illustrative Example”. In table 302, the second column 306₁ divides segments 304₀₋ₘ so that each segment has a table entry 312_{0,1-m,1} containing incarnation numbers 308₀₋ₘ. Each incarnation number is an unsigned integer and represents the number of times the segment containing the incarnation number has been added to the table 302. If the incarnation number is “0”, the segment is either currently deleted from the table, or has never been added. The term “added”, as used herein, means that the segment has been accessed by a program that stores or reads data from the table entries. “Deleted” means that the segment 304 either no longer contains valid data and should not be utilized or that the data within the table entries within the “deleted” segment is removed.

Continuing to look at FIG. 3, it can be seen that a third column 306₂ divides the segments 304₀₋ₘ so that each segment has a table entry 312_{0,2-m,2} containing a nextincarnation number 310₀₋ₘ. Each nextincarnation number 310 is an unsigned integer having a value that is one number higher than the highest achieved incarnation number in the same segment. Therefore, even if a segment has been deleted from the table 302 causing the incarnation number 308 to have a value of 0, the nextincarnation number 310 will remain the value of the previous non-zero incarnation value plus 1. In this way, when a previously deleted segment is again added back to the table, the nextincarnation number 310 can be used to reassign a value to the newly added incarnation number 308. In one embodiment, the incarnation value 308 of the newly added segment is set to the current value of the nextincarnation value 310 contained in that segment and the nextincarnation value 310 is then incremented by a value of 1.

As can be seen in segments 304₁₀₋₁₂, when the table is initially created, all incarnation values 308 are set at zero and all nextincarnation values 310 are set at 1. It should be noted, however, that it is not necessary that the nextincarnation value 310 vary from the highest reached incarnation value 308 by a value of 1. The nextincarnation value 310 is a placeholder and other mathematical increments can be used without departing from the spirit and scope of the invention, such as odd values only, counting by 3, counting by 5, and more.

As an illustrative example, looking to FIG. 3, the segments with the index of values 3 and 4, are “unincarnated” segments because their incarnation values are 0. It is readily determinable that they have been previously incarnated because their nextincarnation value is greater than 1. Segments with index values of 10, 11, and 12 are also unincarnated segments because their incarnation is 0. However, it is apparent that they have not been previously incarnated because their nextincarnation value is equal to 1. All other segments are incarnated because their incarnation values are non-zero. As can be seen from the table 302, in one embodiment, the nextincarnation value 310 of all segments with non-zero incarnation values are always greater than 1. Also, the nextincarnation value is always 1 greater than its respective incarnation value 308, provided the incarnation value is non-zero.

Accessing a Segment

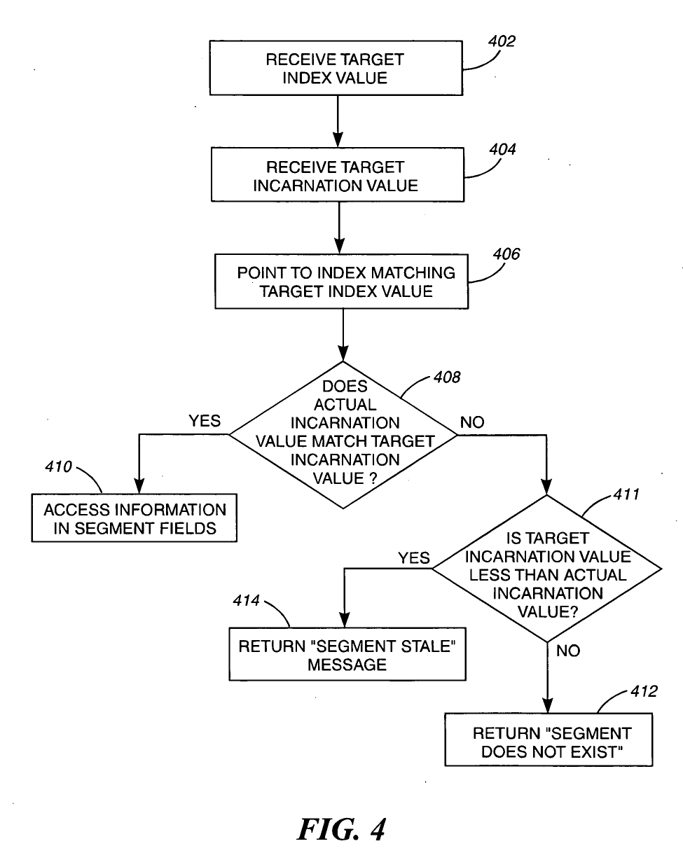

Referring to the table in FIG. 3 as well as the process chart of FIG. 4, a method for accessing a segment in a table, according to one embodiment of the present invention, will now be described. “Accessing” a segment, as used herein, means to read, write, or alter data within the individual table entries 312 within the accessed segment 304. The segments 304 can be accessed sequentially, randomly, or specifically.

If the segment to be accessed is a specified segment, as an initial step, a target index value 314 must be provided in step 402. The target index value will be given to a pointer 316 so that the proper segment is pointed to. The second step 404 is to receive a target incarnation value 308. The target incarnation value 308, as will be explained below, ensures that the requested access is a request for valid data. In step 406, the software loads the target index value into a pointer 316, which points to the segment 304 addressed by the index value 314. Next, in step 408, the incarnation value 308 of the addressed segment 304 is compared to the target incarnation value provided in step 404. Only if the incarnation value 308 contained in the addressed segment 304 exactly matches the target incarnation value, will the segment be properly accessed, step 410.

An incarnation value 308 that does not match the given target incarnation value indicates that the source of the given target incarnation value is not up-to-date with the status of the segment 304 being accessed. An incarnation value that is greater than the given target incarnation value indicates that the segment attempting to be accessed does not yet exist in the table and a message indicating that the segment does not exist will be returned to the source, step 412. Likewise, if the incarnation value contained in the indexed segment 304 is less than the given target incarnation value in step 411, this indicates that the segment being accessed has changed states at least once, i.e., deleted and/or re-added to the table, and the data being sought is now “stale.” A message indicating that the data is stale will be returned in step 414 so that the source accessing the data will know that the data may not be valid.

Deleting a Segment

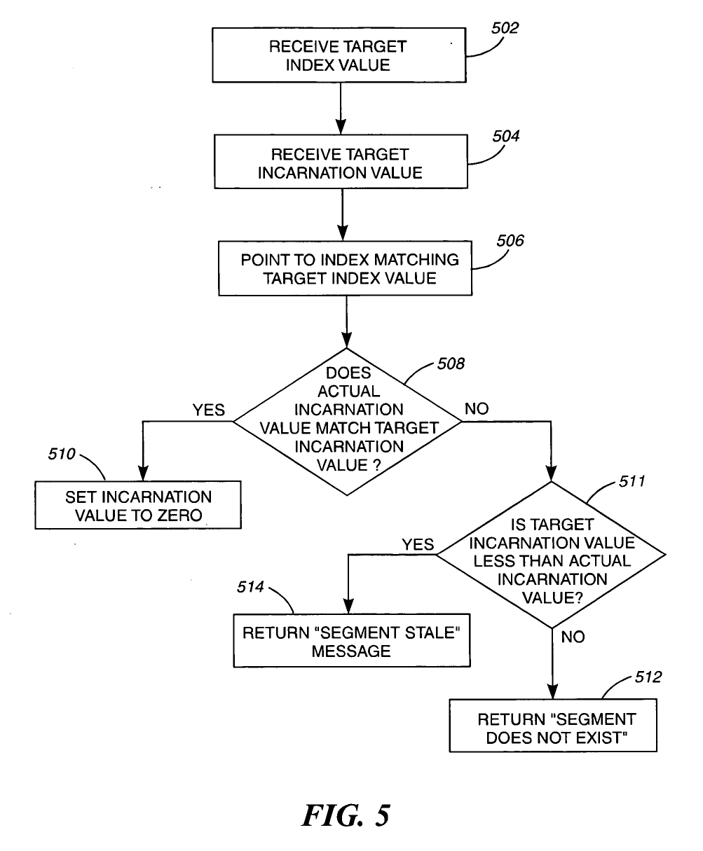

Referring to the table in FIG. 3 as well as the process chart of FIG. 5, a method for deleting a segment in a table, according to one embodiment of the present invention, will now be described. “Deleting” a segment, as used herein, means setting the incarnation value 308 of the segment 304 to a zero value. It can also include changing the value of the data within the table entries to zero values, a default value, or any other manipulation of the data that is appropriate for the purpose of the table 302.

In order to delete a specific segment 304 of a table 302, a target index value 314 is provided in step 502. In a second step 504, a target incarnation value 308 is also provided, which ensures that the requested access is a request for valid data. It is important to note that for the delete function, the incarnation value 308 must be a non-zero value because segments 304 having zero-valued incarnation values 308 have already been deleted. In step 506, the software loads the target index value into a pointer 316, which points to the segment 304 addressed by the index value 314. Next, in step 508, the incarnation value 308 of the addressed segment 304 is compared to the target incarnation value provided in step 504. Only if the incarnation value 308 contained in the addressed segment 304 exactly matches the target incarnation value, will the segment be deleted, i.e., the incarnation value 308 is set to zero, step 510.

An incarnation value 308 that does not match the given target incarnation value indicates that the source of the given target incarnation value is not up-to-date with the status of the segment 304 being accessed. An incarnation value 308 that is greater than the given target incarnation value indicates that the segment 304 attempting to be accessed does not yet exist in the table 302 and a message indicating that the segment 304 does not exist will be returned to the source, step 512. Alternatively, if the incarnation value 308 contained in the indexed segment 304 is less than the given target incarnation value in step 511, this indicates that the segment 304 being accessed has changed states at least once, i.e., deleted and/or re-added to the table 302, and the data being sought is now “stale.” A message indicating that the data is stale will be returned in step 514 so that the source accessing the data will know that the data may not be valid.

In another embodiment, the delete function can start at any given index value and proceed segment by segment searching for non-zero valued incarnation values. Each time it encounters a non-zero incarnation value, the function can delete the segment 304 and continue on or stop at a specified number of deleted segments 304. This can be useful if, for instance, an entire table needs to be deleted, or if a specified amount of memory needs to be cleared.

Adding a Segment

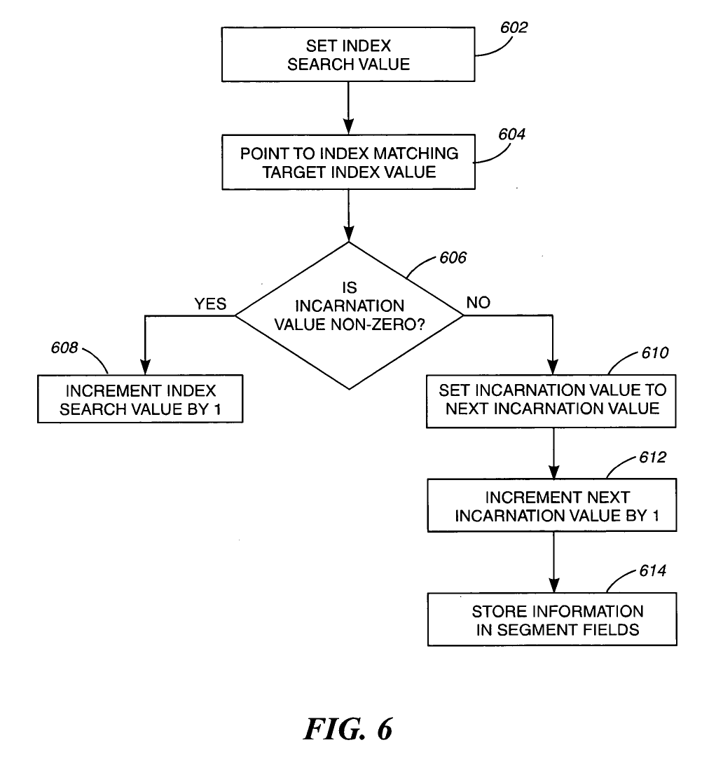

Referring to the table in FIG. 3 as well as the process chart of FIG. 6, a method for adding a segment to a table, according to one embodiment of the present invention, will now be described. “Adding” a segment, as used herein, means changing a zero-valued incarnation value 308 of a segment 304 to a non-zero value. It can also include placing data within the table entries 312 of the table 302.

In one embodiment, a segment 304 will be added to the lowest index numbered segment available. In other embodiments, the index 314 of the segment 304 to be added can be specified. The process chart of FIG. 6 shows a method for adding a segment 304 to the lowest index numbered segment available. So that the function will begin looking at the first segment, 304₀, a target index value of zero is provided in step 602. In step 604, the software loads the target index value into a pointer 316, which points to the first segment 304₀ in the table 302. Next, in step 606, the incarnation value 306 of the addressed segment 304₀ is compared to zero. This is because a segment can only be added if it is currently either deleted from the table or has not yet been added for the first time. An incarnation value of zero is indicative of both of these circumstances. If the incarnation value is non-zero, the pointer value is incremented by 1, step 608, and the process returns to step 604, where the next segment is looked at and compared to zero.

If the incarnation value 308 is equal to zero, the incarnation value 308 is set to equal the value of the nextincarnation value 310, step 610, which now gives the segment 304 an incarnation value that is 1 greater than it's last previous incarnation value. In this way, it can be determined how many times the segment 304 has been added to the table 302. Next, in step 612, the nextincarnation value is incremented by 1. The segment is now added to the table and as an optional final step, data can be stored in the table elements, step 614.

### ILLUSTRATIVE EXAMPLE

As an illustrative example, the inventive table 302 of the present invention is used to store information pertaining to computer resources. For instance, each segment 304 in the table 302 is dedicated to a particular hardware resource, with each table entry in the segment containing an attribute of that hardware resource. Referring again to the computer system shown in FIG. 1, it can be seen that a computer system has a plurality of components. The components may be removed from the system temporarily or permanently. The components may also be replaced by other components and completely new components may be added to the system. In a distributed computing environment, accurate management of resources is desirable.

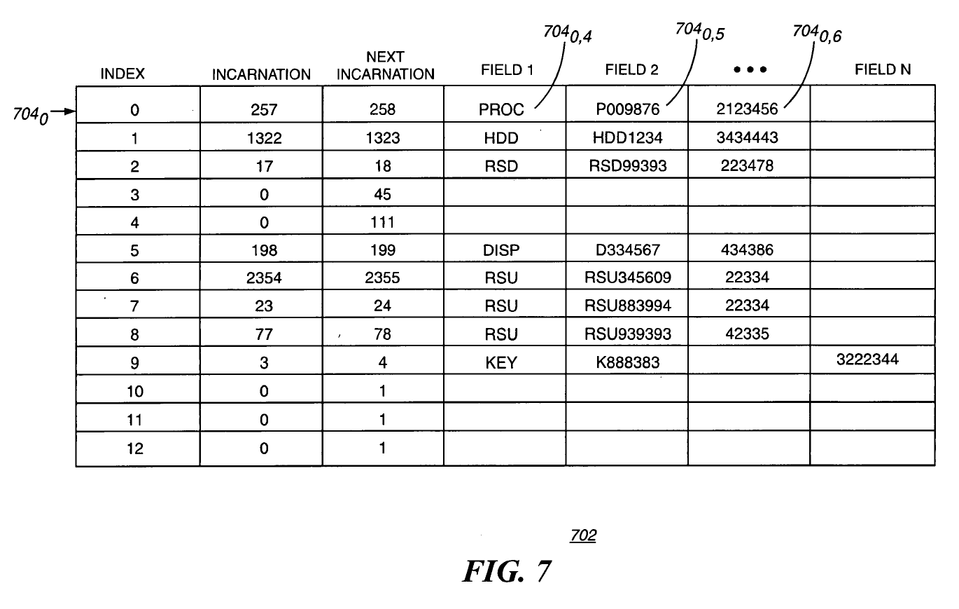

Referring now to FIG. 7, a table 702 is shown populated with information pertaining to the computer system shown in FIG. 1. Segment 0, 704₀, contains information pertaining to the processor 104, which is identified in table entry 704_{0,4}. Table entry 704_{0,5} contains a serial or other identifying number of the specific device and table entry 704_{0,6} contains other information about the resource, such as speed, size, or any other attribute. Although not shown in FIG. 7, there may be several other table entries populated with information pertaining to the processor 104, such as location of the device, date of manufacture, date of last service, and other similar information.

If the processor 104 is removed from the computer system shown in FIG. 1, segment 0 in table 702 will be deleted from the table to indicate that the resource is no longer part of the system and no longer available. If the processor is once again made available to the computer system, the segment 704₀ can be added back into the table, or the processor information can be stored in a different segment. The incarnation value for the processor in table 702 is 257, meaning that segment 0 has been added to the table 257 times. The nextincarnation value is the placeholder for the next time the segment is added to the table, which will be the 258^{th} time.

The processor information can be readily accessed by pointing to the segment containing the resource information and confirming that the incarnation number matches the incarnation number provided with the access instruction. However, if an instruction were given to access the processor information in segment 0, but the incarnation given was 256 instead of 257, the present invention will identify the request for access as a request for access to stale data. It is readily discernable that the segment has been deleted and added to the table one time since the request was last valid; Alternatively, if the incarnation value given in the request instruction was 258, it is readily discernable that the segment has not yet been added to the table 258 times yet and that the information being sought does not yet exist.

Sparseness

As described above, the present invention is a table whose row, or segment, indices remain constant after other segments are added or deleted. The table remains non-sparse because unused “hole” segments are reused (they could be put in a free chain for easy discovery by the “add segment” function). The only condition giving rise to a potentially too-sparse table would be adding many segments and then deleting all but one or more near the end of the table.

In one embodiment, a sparseness indicator is maintained and made accessible through a function, giving notice of when it might be desirable to move a segment “down” to a lower Index (with a new Incarnation based upon the Nextincarnation of the Index being relocated to) via an Index/Incarnation “swapping” function (caller would then need to notify other consumers of the original Index/Incarnation pair of the change). Index/Incarnation pairs can be rediscovered by iterating the table, skipping over unused segments (i.e. those whose Incarnation is zero).

Importantly, all segment accesses are essentially direct index accesses, with slight overhead to verify matching incarnation.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for managing a segment in a table, the method comprising:
generating a table with one or more addressable segments, where each segment has a plurality of table entries including at least one table entry for storing an incarnation value representing one of:
a number of times the segment has been added to the table; and
a zero value if the segment is currently deleted from the table;
setting a value of a pointer that points to an addressable segment of the table;
reading the incarnation value in the table entry within the addressable segment pointed to by the pointer, and in response to the incarnation value being zero, incrementing the first pointer value by a predetermined quantity.

2. The method according to claim 1, further comprising:
accessing a segment in the table by reading the incarnation value in the table entry within the addressable segment pointed to by the pointer, and in response to the incarnation value being non-zero, comparing the incarnation value to a given incarnation value, and in response to the incarnation value being equal to the given incarnation value, accessing one or more of the table entries within the segment.

3. The method according to claim 1, further comprising:
deleting a segment in the table by reading the incarnation value in the table entry within the addressable segment pointed to by the pointer, and in response to the incarnation value being non-zero, comparing the incarnation value to a given incarnation value, and in response to the incarnation value being equal to the given incarnation value, setting the incarnation value to zero.

4. The method according to claim 1, further comprising:
reading the incarnation value in the table entry within the addressable segment corresponding to the pointer value, and in response to the incarnation value being non-zero, comparing the incarnation value to a given incarnation value, and in response to the incarnation value being
less than the given incarnation value, returning a status indicating that the given incarnation value is stale; and
greater than the given incarnation value, returning a status indicating that the given incarnation value is invalid.

5. The method according to claim 1, wherein the addressable segments comprise rows.

6. The method according to claim 5, wherein each table entry comprises a column.

7. A method for adding a segment to a table, the method comprising:
generating a table with one or more addressable segments, where each segment has a plurality of table entries including at least one table entry for storing an incarnation value representing one of:
a number of times the segment has been added to the table; and
a zero value if the segment is currently deleted from the table;
and at least one table entry for storing a nextincarnation value that is defined as a mathematical incremental offset added to a highest obtained value of the incarnation value;
setting a value of a pointer that points to an addressable segment of the table;
reading the incarnation value in the table entry within the addressable segment corresponding to the pointer value, and in response to:
the incarnation value being non-zero, incrementing the first pointer value by a predetermined mathematical increment; and
the incarnation value being zero, setting the incarnation value to the value of the nextincarnation value and incrementing the nextincarnation value by the mathematical incremental offset.

8. The method according to claim 7, further comprising:
accessing the table entries within the segment.

9. The method according to claim 7, wherein the addressable segments comprise rows.

10. The method according to claim 9, wherein each table entry comprises a column.

11. A computer program product for managing a segment in a table, the computer program product comprising:
a storage medium readable by a processing circuit and storing instructions for execution by the processing circuit for performing a method comprising:
generating a table with one or more addressable segments, where each segment has a plurality of table entries including at least one table entry for storing an incarnation value representing one of:
a number of times the segment has been added to the table; and
a zero value if the segment is currently deleted from the table;
setting a value of a pointer that points to an addressable segment of the table;
reading the incarnation value in the table entry within the addressable segment pointed to by the pointer, and in response to the incarnation value being zero,
incrementing the first pointer value by a predetermined quantity.

12. The computer program product according to claim 11, further comprising:
accessing a segment in the table by reading the incarnation value in the table entry within the addressable segment pointed to by the pointer, and in response to the incarnation value being non-zero, comparing the incarnation value to a given incarnation value, and in response to the incarnation value being equal to the given incarnation value, accessing one or more of the table entries within the segment.

13. The computer program product according to claim 11, further comprising:
deleting a segment in the table by reading the incarnation value in the table entry within the addressable segment pointed to by the pointer, and in response to the incarnation value being non-zero, comparing the incarnation value to a given incarnation value, and in response to the incarnation value being equal to the given incarnation value, setting the incarnation value to zero.

14. The computer program product according to claim 11, further comprising:
reading the incarnation value in the table entry within the addressable segment corresponding to the pointer value, and in response to the incarnation value being non-zero, comparing the incarnation value to a given incarnation value, and in response to the incarnation value being
less than the given incarnation value, returning a status indicating that the given incarnation value is stale; and
greater than the given incarnation value, returning a status indicating that the given incarnation value is invalid.

15. The computer program product according to claim 11, wherein the addressable segments comprise rows.

16. The computer program product according to claim 15, wherein each table entry comprises a column.

17. A method for adding a segment to a table, the method comprising:
generating a table with one or more addressable segments, where each segment has a plurality of table entries including at least one table entry for storing an incarnation value representing one of:
a number of times the segment has been added to the table; and
a zero value if the segment is currently deleted from the table;
and at least one table entry for storing a nextincarnation value that is defined as a mathematical incremental offset added to a highest obtained value of the incarnation value;
setting a value of a pointer that points to an addressable segment of the table;
reading the incarnation value in the table entry within the addressable segment corresponding to the pointer value, and in response to:
the incarnation value being non-zero, incrementing the first pointer value by a predetermined mathematical increment; and
the incarnation value being zero, setting the incarnation value to the value of the nextincarnation value and incrementing the nextincarnation value by the mathematical incremental offset.

18. The method according to claim 17, further comprising:
accessing the table entries within the segment.

19. The method according to claim 17, wherein the addressable segments comprise rows.

20. The method according to claim 19, wherein each table entry comprises a column.

21. A computer system for managing a plurality of resources, the computer system comprising:
a table with one or more addressable segments, where each segment has a plurality of table entries including at least one table entry for storing an incarnation value representing one of:
a number of times the segment has been added to the table; and
a zero value if the segment is currently deleted from the table;
a processor for transmitting data into the addressable segments of the table, the processor including a means operable for:
setting a value of a pointer that points to an addressable segment of the table; and
reading the incarnation value in the table entry within the addressable segment pointed to by the pointer, and in response to the incarnation value being zero, incrementing the first pointer value by a predetermined quantity.

22. A computer system for managing a plurality of resources, the computer system comprising:
a table with one or more addressable segments, where each segment has a plurality of table entries including:
at least one table entry for storing an incarnation value representing one of:
a number of times the segment has been added to the table; and
a zero value if the segment is currently deleted from the table; and
at least one table entry for storing a nextincarnation value that is defined as a mathematical incremental offset added to a highest obtained value of the incarnation value;
a processor for transmitting data into the addressable segments of the table, the processor including a means operable for:
setting a value of a pointer that points to an addressable segment of the table;
reading the incarnation value in the table entry within the addressable segment pointed to by the pointer, and in response to:
the incarnation value being non-zero, incrementing the first pointer value by a predetermined mathematical increment; and
the incarnation value being zero, setting the incarnation value to the value of the nextincarnation value and incrementing the nextincarnation value by the mathematical incremental offset.
